(19) United States
(12) Patent Application Publication
(10) Pub. No.: US 2006/0015361 A1
(43) Pub. Date: Jan. 19, 2006

(54) Method and system for customer contact reporting

(76) Inventors: Jurgen Sattler, Wiesloch (DE); Joachim Gaffga, Wiesloch (DE)

Correspondence Address: KENYON & KENYON, 1500 K STREET NW, SUITE 700, WASHINGTON, DC, 20005, US

(21) Appl. No.: 11/026,054

(22) Filed: Jan. 3, 2005

Related U.S. Application Data
(60) Provisional application No. 60/588,389, filed on Jul. 16, 2004.
(60) Provisional application No. 60/623,870, filed on Nov. 2, 2004.

(51) Int. Cl. G06Q 99/00

(52) U.S. Cl. 705/1

(57) ABSTRACT

A method and system for customer contact reporting. In embodiments, a document may be generated at a first computer system that has contact report fields. Appointment data may be extracted from a groupware application's data set, and data may be entered within the contact report fields in the document based on the extracted appointment data.

### CROSS-REFERENCE TO RELATED APPLICATIONS

This application claims the benefit for purposes of priority to U.S. App. No. 60/588,389, filed Jul. 16, 2004, and U.S. App. No. 60/623,870, filed Nov. 2, 2004.

### BACKGROUND INFORMATION

In many environments, a salesperson is responsible to record customer contact on the basis of activities such as visiting a customer site. Customer contacts may be product related or unrelated to the salesperson's product responsibilities. Salespersons may be required to record a summary about sales activities on a timely basis (e.g., daily, monthly, yearly, etc.). Sales activities may include customer contact and visits. Customer contact reporting involves recording details of a salesperson's visit to a customer site and/or other interaction with a customer. A customer contact report may include details regarding time, date, persons in attendance, discussion notes, etc. For example, a salesperson may be required to produce a customer contact report after interacting with a customer.

A salesperson may use a groupware calendar to keep track of appointments with customers. Known groupware applications do not allow a user of an application program, e.g., calendar application, to associate an appointment indicating a customer interaction with a report form. The user thus has two separate files and/or software programs to record data relating to the customer contact, the appointment software and the report form. Known systems do not allow for use of these two files in conjunction to facilitate the user's business tasks. Accordingly, the present inventors perceive these and other needs in the art.

### BRIEF DESCRIPTION OF THE DRAWINGS

FIG. 1 shows an exemplary system according to an embodiment of the present invention.

FIG. 2 shows an example of a form as processed according to another exemplary system according to an embodiment of the present invention.

FIG. 3 shows another exemplary form according to an embodiment of the present invention.

FIG. 4 shows an exemplary embodiment according to the present invention.

FIG. 5 shows an exemplary method according to an embodiment of the present invention.

### DETAILED DESCRIPTION

Some embodiments of the present invention provide methods and systems for supporting a salesperson in generating a customer contact report. The method and system of the present invention may provide a customer contact report form in which form data is generated from data objects of another application program, e.g., a groupware calendar application. The customer contact report form may include customer information, date, time, product information, salesperson information, etc.

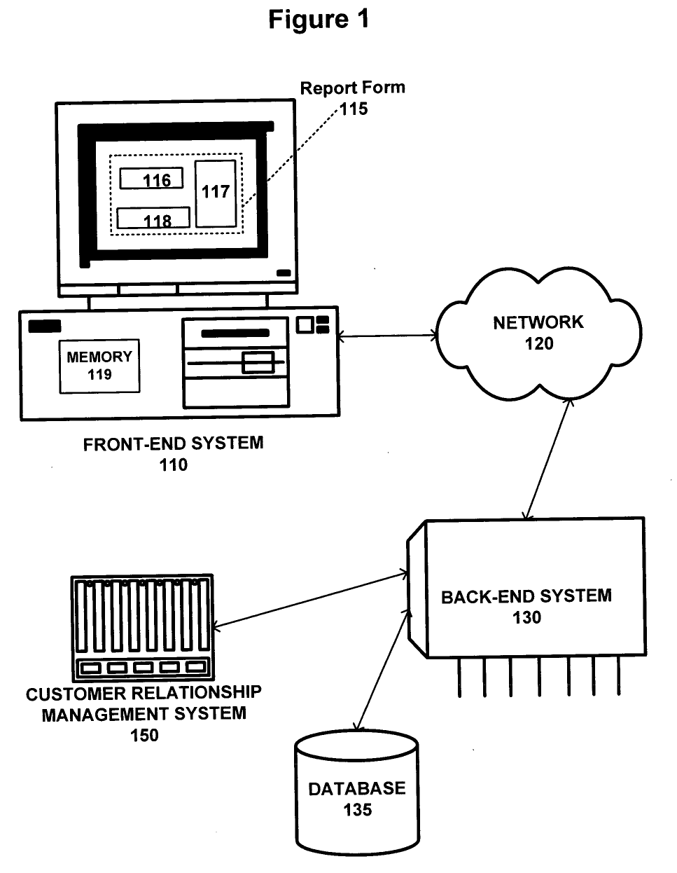

FIG. 1 shows an exemplary system according to an embodiment of the present invention. The system includes a front-end system 110, a network 120, a back-end system 130, a database 135, and a customer relationship management (CRM) system 150. Front-end system 110 may be any type of device for running application software, such as for example a personal computer, a terminal, a personal digital assistant (PDA), etc. Network 120 may be any type of network for communicating information, such as a local area network (LAN), wide area network (WAN), the Internet, or an Intranet. Back-end system 130 may be a terminal server, mainframe computer, or any type of computer system that services users over network 120. Typically, many front-end systems may be coupled to back-end system 130 through network 120. The back-end system 130 may include CRM 150 and database 135. The database 135 may be any type of computer readable medium, such as one or more hard disk memories, that stores instructions and data for a knowledge warehouse system that maintains a collection of data to support a decision making process. The CRM system 150 may be any type of device for running application software for the automation of sales, marketing and support business functions, such as for example a personal computer, a terminal, a personal digital assistant (PDA), etc.

As shown in FIG. 1, front-end system 110 is displaying the text of form 115, which contains a plurality of contact report fields 116-118. In some embodiments, a user running an application program on front-end system 110 may be prompted to enter information into fields 116-118 on form 115. Front-end system 110 also contains a memory 119, which may be for example a Random Access Memory (RAM). The system shown in FIG. 1 supports a form 115 that is generated based on information from data in another application program, e.g., a groupware calendar application on the front-end system 110. Form 115 is a pre-filled with the data from the application program.

An exemplary embodiment of the present invention may provide reporting capabilities in a customer relationship management system 150, e.g. SAP CRM, that may be included in the back-end system 130. Additionally, the front-end system 110 may include third party groupware calendar applications, e.g., Lotus Notes, Microsoft Exchange, Microsoft Outlook, etc. Of course, a calendar application may perform other functions in addition to calendar functions. The user may trigger a customer contact report from a menu bar of a calendar appointment in the groupware calendar application, e.g., Microsoft Outlook. The data operated on by the groupware calendar application may be considered to be the groupware calendar application's data set. A customer contact report form may be a single interaction form or a multiple interaction form. The single contact report form relates to a single customer interaction (visit). The multiple contact form relates to reporting all interaction with a customer during a specific date range for which the system has obtained calendar entries and has generated the multiple interaction report form as e.g., a spreadsheet. Before a form is generated, a relation to the calendar appointment has to be ensured. Additionally, some embodiments of the present invention provide for a customer report form that may be implemented as a form in a groupware application (e.g., calendar application), a Microsoft Excel spreadsheet including Visual Basic for Applications (VBA) Code to extract groupware data from calendar appointments, an attachment that is assigned to a calendar appointment, an InfoPath form, a MS Word document, and/or Adobe Portable Document (PDF) Form. The form may be customized to meet the reporting requirements of a user and a work environment. For example, a customer report form may include date, time, contact, and other data extracted from the groupware calendar application. Also, product value help data may be generated and included in the customer report by a back-end system.

The customer contact form 115 may be generated by using predefined procedures framework in a back-end system 130. For example, a back-end system 130 may use a customer relationship management activity in the CRM system 150 to generate the contact report form 115. In an exemplary embodiment according to the present invention, the form 115 is generated from data objects stored by a calendar application, e.g., Microsoft Outlook, on front-end system 110. The predefined procedures may allow the processing of data in the back-end system 130. For example, when a user generates a groupware calendar appointment in an application program on the front-end system 110, the data is mapped in the back-end system 130 to a data object.

Also, the customer contact report 115 may be generated via use of an active form. An exemplary embodiment according to the present invention provides an active form in a computer-based portal or in a public folder of a computer system which may be used offline or online. A function/script in the active form collects groupware calendar data to generate a report form 115, e.g., a customer contact report. Also, the exemplary embodiment provides an active form for single customer contact reporting via an appointment application executed by a back-end system 130. A customer contact report form 115 includes product data, which is customizied within a process to support the maintainance of the report. A single customer contact report form may be made available to a user via an attachment to a groupware calendar appointment or via other computer network access points (e.g., without data pre-filled). Also, a multiple customer contact report form (e.g., spreadsheet) may be made available to a user via a computer portal system and/or a public folder of a computer network.

In an exemplary embodiment according to the present invention, after the customer contact report form 115 is completed, the form 115 is sent by a user from the front-end system 110 to the back-end system 130 for processing. In the back-end system 130, data submitted via the completed form 115 is used to adjust customer relationship manangement (CRM) activities in the CRM system 150.

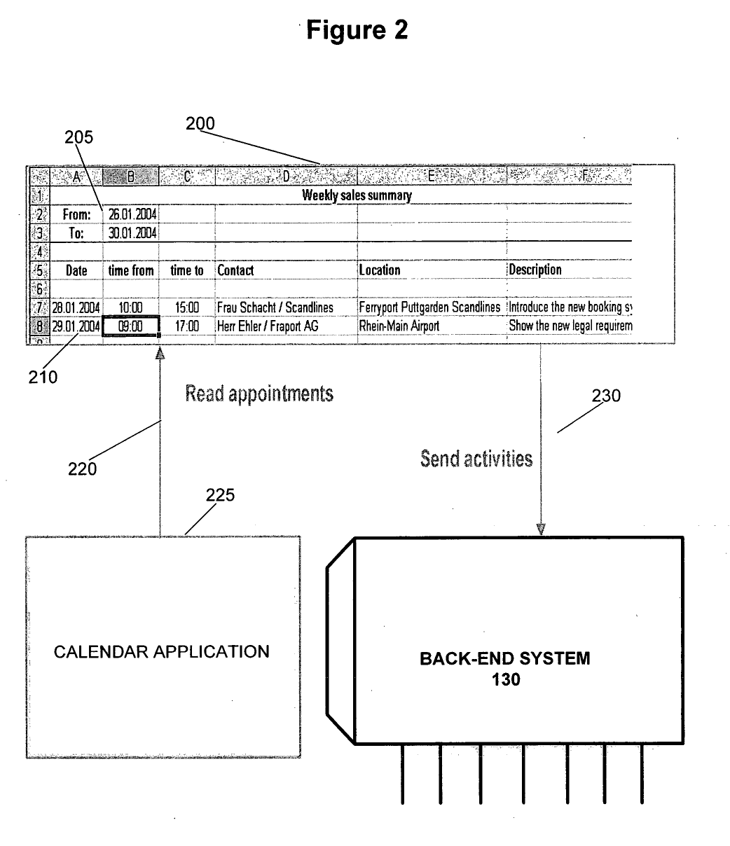

FIG. 2 shows an example of a form as processed according to another exemplary system according to an embodiment of the present invention. In FIG. 2, a user interacts with a form 200 (which is an example embodiment of form 115 in FIG. 1) for multiple customer contact appointments. In this example, form 200 is implemented as a spreadsheet in an application, e.g., Microsoft Excel. The form 200 is displayed to the user on a front-end system 110. Form 200 may be populated by reading 220 appointment data stored in a calendar application 225, e.g., Microsoft Outlook, on the front-end system 110 of FIG. 1. In FIG. 2, the form 200 displays a weekly sales summary. Field 205 shows the dates of the week for which the form 200 displays appointments. The user interacts with form 200 (e.g., through a spreadsheet application program) and may edit a row 210 of the form 200. The user edits the row 210 to correct information and to enter additional information regarding the appointment. Appointment data in form 200 may include date, time from, time to, contact, location, and description. In some embodiments, the form also includes fields that are pre-populated with information relevant to the customer contact for use in providing details about the customer contact. For example, the pre-populated information may include identifying information for a plurality of products. The products may be selected based on stored information about the person making the customer contact (i.e., those products assigned to a salesman) or information about the customer being contacted. In an embodiment, the person completing the customer contact form may then select from pre-populated information further details about the customer contact to be reported. For example, the person completing the customer contact form may then select those products that were discussed as a further detail provided in the customer contact report. When the user submits the completed form 200, form data and related CRM activites are sent 230 to a back-end system 130. In embodiments, a user may record on the form identifying information for a product ordered during the customer contact and, by submitting the form, the back-end system may automatically cause the products identified product to be ordered.

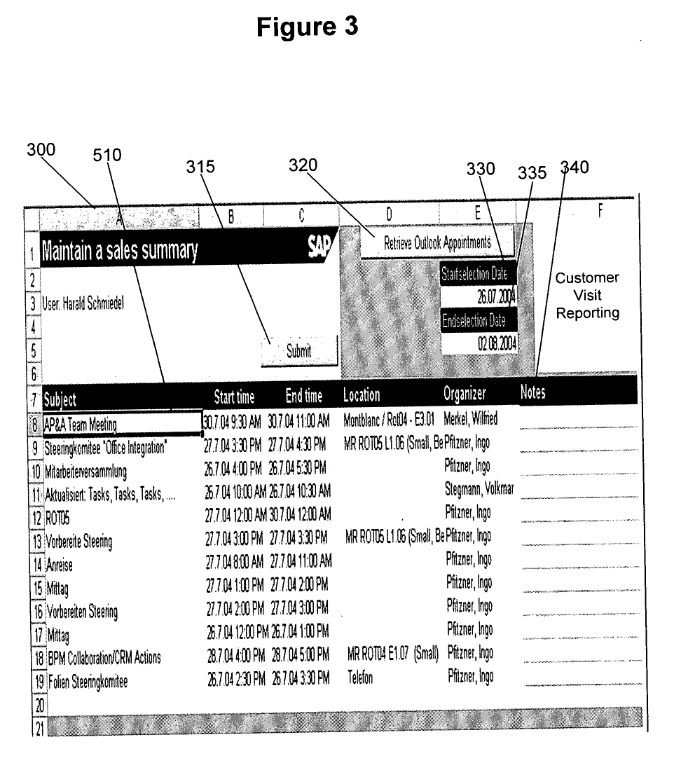

FIG. 3 shows another exemplary form according to an embodiment of the present invention. In some embodiments, the groupware program uses the Microsoft Office Add-in (plug-in) feature to provide customer contact reporting. Again, the form 300 is shown as a spreadsheet, e.g., a Microsoft Excel Sheet. The form 300 provides for a multiple customer report that facilitates mass data reporting. A user selects groupware calendar data and contact data to fill a spreadsheet by first entering a start date in field 330 and an end date in field 335. Then the user clicks on retrieve appointments button 320 in order to obtain calendar appointment data for the date range entered in fields 330 and 335. Then the appointment data is displayed in the form 300 such that each row 310 in the spreadsheet corresponds to one calendar appointment. In this multiple customer report form 300, the only manual task required of the user is to input the long-text description (summary) for each appointment in the notes fields 340. When the form 300 is completed by the user, form data is sent by the user to a back-end system 330 for further processing by clicking the submit button 315, which may initiation the predefined procedures as discussed above.

In an exemplary embodiment of the presented invention, the form may be implemented as a Portable Document Format (PDF) document, e.g., Abode PDF. The PDF form may provide for a single customer contact report. The PDF form relates to a single appointment of a user (e.g., salesperson). The user edits and supplements the PDF form with additional data via fields. The PDF form provides that the user may use less effort in writing a customer contact report. Customer contact data is partly pre-filled by the exemplary embodiment of the present invention. Also, the task involved with preparing a customer contact report is facilitated by product value help data, e.g., product information relating to a salesperson's product responsibilities, provided by the PDF form. After the user completes the PDF form, the user sends the form data to a back-end system 130 for further processing by clicking on an online send button or an offline send button in the PDF form.

According to another exemplary embodiment of the present invention, the form may provide customer contact reporting for a single customer contact. For example, a salesperson may open a groupware application, e.g., Microsoft Outlook. The salesperson may open a calendar appointment stored in the groupware application. The methods and systems of the present invention provide that a form is generated on the basis of data stored in relation to the appointment in the groupware application. The form includes fields that are already filled with values from the calendar appointment. Such fields may include business partner, contact person, territory, date, time from, time to, etc. Next, the salesperson corrects values in the form which may not correspond to the real values according to the actual customer contact, e.g. customer site visit, teleconference with customer, etc. Then the salesperson fills in the fields that are not pre-filled with calendar data (e.g., summary of the interaction with the customer(s)). The salesperson saves the form after completion by clicking a Save/Send button in a user interface. The data of the complete form is then synchronized with the back-end system 130. The form is generated on the basis of the calendar appointment, if it exists in the groupware application. When an appointment does not exist in the calendar application, a report form may be sent to the back-end system either immediately (online case) or later when synchronizing (offline case). If the appointment does not exist, the user may access a template report form that is not pre-filled via a computer-based portal, a public folder (file system or groupware public folder) and/or a local data storage medium (file system) of a computer system which may be used offline or online. Also, if the appointment does not exist, the user may modify the calendar of the groupware application to include a calendar entry. This calendar entry may be used at a later point of time to generate a report form.

In some embodiments, a user may interact with a menu bar that may have been added to the graphical interface for a groupware calendar. The user may click on a menu option in order to trigger generation of a pre-filled form (such as form 115) based on the data of the appointment in the calendar. In some embodiments, pre-filled form (such as form 115) generation is triggered from a groupware calendar. A user may interact with the calendar to indicate the day(s) for customer contact reporting. For a multiple customer contact report, the user interacts with a calendar and chooses in the menu bar ‘Actions’—‘Create Contact Report’ or pushes a button ‘Create Business Object’. As a result, a spreadsheet may open for the mass reporting of multiple customer contacts.

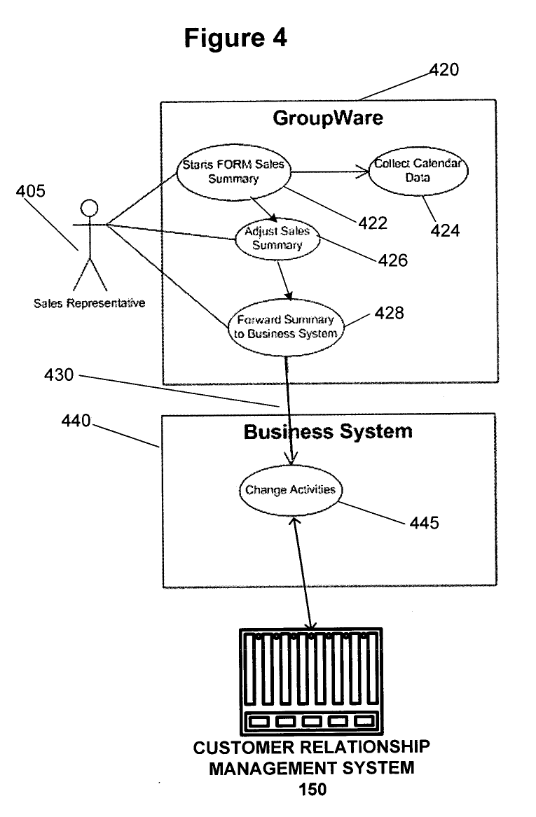

FIG. 4 shows an exemplary embodiment of the present invention. First, the salesperson or sales representative 405 uses a groupware application 420 to start working on a customer contact reporting form 422. The groupware application may be on a front-end system 110. The form is generated by collecting calendar data 424 and then the salesperson 405 adjusts the form by editing data and including a sales summary 426. After the user has completed the form, the user forwards 428, 430 the form to a business system 440 such as a back-end system 130. In the business system 440, the data of the completed form is used to change activities and stored data in the CRM system 450.

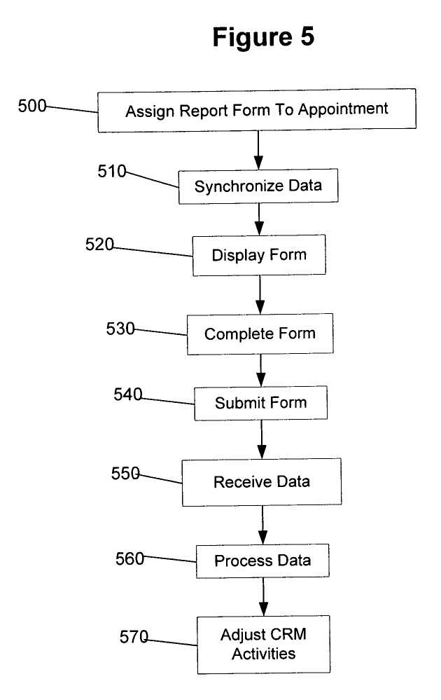

FIG. 5 shows an exemplary embodiment of a method according to the present invention. Front-end system 110 functions are performed including generating a CRM activity and generating a data object in a database 135. A data object stores data associated with functions and with business and/or input/output event. A customer contact report form 115 is generated and stored by the front-end system 110. In step 500, the report form 115 is assigned to an appointment in a groupware calendar application. In an embodiment, a customer report form may be generated when an activity or appointment is created in a calendar (e.g., by selecting a report option), and the report form may be attached to the activity or appointment (e.g., as a PDF document). Step 510 involves synchronizing (loading) data between a calendar appointment stored in front-end system 110 and the report form 115. The form 115 includes initial data based on data of the calendar appointment. In step 520, a form 115 is displayed to a user on a front-end system 110. Then in step 530, the user completes the form 115 by entering data into the form 115. The entered data may include additional data regarding the customer interaction and order data for products and/or services to be provided to the customer. Then in step 540, the user submits the completed form 115 by clicking on a user interface button. The initial data and entered data of the form 115 is read by the system according to an embodiment of the present invention and then transmitted offline (e.g., via e-mail and/or Simple Mail Transfer Protocol (SMTP)) or online (e.g., Hyper TextTransfer Protocol (HTTP)) from the user front-end system 110 to a back-end system 130 via a computer communication network 120. In step 550, the back-end system 130 receives and stores the data from the completed form 115. The back-end system 110 processes the data in step 560. The data may be processed via a predefined procedure framework. In processing the data, the form is matched to its corresponding CRM activity. In step 570, CRM activities are adjusted in the CRM system 150 on the basis of the data. The CRM activities may be adjusted via web services provided by system 110, network 120, system 130, CRM 150, and/or database 135. Web services provide a framework for the exchange of Extensible Mark-up Language (XML) messages via web-based protocols such as Simple Object Access Protocols (SOAP), Web Services Definition Language (WSDL), and Universal Description Discovery and Integration (UDDI). The predefined procedure framework maps the fields of the report form and the data from the completed form 115 to the corresponding web service(s) for purposes of adjusting CRM activities.

The method according to the present invention may be stored as a set of instructions that is accessible and executable by a processor. The processor may include a computer server arrangement. The set of instructions may be stored on a machine readable medium that is any medium capable of being read by a machine such as a compact disk, hard drive memory, floppy disk memory, DVD-ROM, CD-ROM or any type of machine-readable (computer-readable) storing medium. The set of instructions may be included within a computer program (which as is well known comprises a plurality of instructions) that is executable by a computer system.

The above is a detailed discussion of the certain embodiments. It may be understood that the examples discussed are for illustration purposes only and are not intended to limit the configuration to that shown. For example, in some embodiments, the customer contact report form may not be pre-filled. It is of course intended that the scope of the claims may cover other embodiments than those described above and their equivalents.

What is claimed is:

1. A method for customer contact reporting, the method comprising:
generating at a first computer system a document comprising a form, the form comprising a plurality of contact report fields;
extracting appointment data for a customer contact from a calendar application's data set; and
entering data within the contact report fields in the document based on the extracted appointment data.

2. The method of claim 1, wherein the method further comprises:
forwarding the document from the first computer system to a customer relationship management system.

3. The method of claim 2, wherein the method further comprises:
adjusting an activity data object in the customer relationship management system based on data in the contact report fields in the document.

4. The method of claim 3, wherein the activity data object that is adjusted was created based on receipt of the document at the customer relationship management system.

5. The method of claim 1, wherein the document is a spreadsheet formatted document.

6. The method of claim 1, wherein the document is a Portable Document Format document.

7. The method of claim 1, wherein the contact report fields include data fields for at least one of business partner data, contact person data, territory data, appointment data, date data, time data, and product value help data.

8. The method of claim 1, wherein the calendar application is a groupware calendar application.

9. The method of claim 1, wherein the document further comprises fields that are pre-populated with information relevant to the customer contact for use in providing details about the customer contact.

10. The method of claim 9, wherein the pre-populated information comprises identifying information for a plurality of products.

11. The method of claim 1, wherein the method further comprises:
recording identifying information for a product ordered during the customer contact; and
submitting the document, wherein said submitting automatically causes the identified product to be ordered.

12. A machine-readable medium storing a set of instructions, the set of instructions capable of being executed by a processor to implement a method in a computer system comprising:
generating at a first computer system a document comprises a form, the form comprising a plurality of comprising contact report fields;
extracting appointment data for a customer contact from a calendar application's data set; and
entering data within the contact report fields in the document based on the extracted appointment data.

13. The machine-readable medium of claim 12, wherein the method further comprises:
forwarding the document from the first computer system to a customer relationship management system.

14. The machine-readable medium of claim 13, wherein the method further comprises:
adjusting an activity data object in the customer relationship management system based on data in the contact report fields in the document.

15. The machine-readable medium of claim 14, wherein the activity data object that is adjusted was created based on receipt of the document at the customer relationship management system.

16. The machine-readable medium of claim 12, wherein the document is a spreadsheet formatted document.

17. The machine-readable medium of claim 12, wherein the document is a Portable Document Format document.

18. The machine-readable medium of claim 12, wherein the contact report fields include data fields for at least one of business partner data, contact person data, territory data, appointment data, date data, and time data.

19. The machine-readable medium of claim 12, wherein the calendar application is a groupware calendar application.

20. The machine-readable medium of claim 12, wherein the document further comprises fields that are pre-populated with information relevant to the customer contact for use in providing details about the customer contact.

21. The machine-readable medium of claim 20, wherein the pre-populated information comprises identifying information for a plurality of products.

22. The machine-readable medium of claim 12, wherein the method further comprises:
recording identifying information for a product ordered during the customer contact; and
submitting the document, wherein said submitting automatically causes the identified product to be ordered.

23. A method for customer contact reporting, the method comprising:
creating an appointment entry in a calendar application based on a set of appointment data;
determining if an option was selected to generate a customer report and, if so, performing the following:
generating a document comprising a form, the form comprising a plurality of contact report fields;
extracting data from the calendar entry that was created;
entering data within the contact report fields in the document based on the extracted data; and
attaching the document to the calendar entry.

24. The method of claim 23, wherein the document is attached to the calendar entry as a Portable Document Format document.

25. The method of claim 23, wherein the contact report fields include data fields for at least one of business partner data, contact person data, territory data, appointment data, date data, time data, and product value help data.

26. The method of claim 23, wherein the calendar application is a groupware calendar application.

27. The method of claim 23, wherein the document further comprises fields that are pre-populated with information relevant to the customer contact for use in providing details about the customer contact.

28. The method of claim 23, wherein the method further comprises:
recording identifying information for a product ordered during the customer contact; and
submitting the document, wherein said submitting automatically causes the identified product to be ordered.
